(19) United States
(12) Patent Application Publication
(10) Pub. No.: US 2017/0134791 A1
(43) Pub. Date: May 11, 2017

(54) METHOD AND DEVICE FOR INFORMATION SYNCHRONIZATING

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Min WANG, Tianjin (CN); Feng PAN, Tianjin (CN)

(21) Appl. No.: 15/246,344

(22) Filed: Aug. 24, 2016

Related U.S. Application Data
(63) Continuation of application No. PCT/CN2016/089119, filed on Jul. 7, 2016.

(30) Foreign Application Priority Data
Nov. 9, 2015 (CN) 201510759723.4

(51) Int. Cl. H04N 21/43; H04N 21/435; H04N 21/41; H04N 21/4788; H04N 21/45

(52) U.S. Cl. CPC H04N 21/4302; H04N 21/4788; H04N 21/4532; H04N 21/4126; H04N 21/435

(57) ABSTRACT

An embodiment of the present disclosure discloses an information synchronization method, device and system for solving the problem of complicated operation caused by the reason that users need to manually enter a subject name to join the subject discussion. The technical solution comprises steps of acquiring information of a program which is being currently played; determining if a microblog account logs in on the TV; and if so, acquiring the microblog login information; sending the program information and the microblog login information to a microblog server such that the microblog server sends the program information to a mobile terminal corresponding to the microblog login information. The technical solution according to an embodiment of the present disclosure is capable of being applied to terminal device such as TVs, achieving a function of quickly joining microblog discussion.

### CROSS-REFERENCE TO RELATED APPLICATIONS

This application is a continuation of International Application No. PCT/CN2016/089119 filed on Jul. 7, 2016, which is based upon and claims priority to Chinese Patent Application No. 201510759723.4, filed to the State Intellectual Property Office of The PRC on Nov. 9, 2015, the entire contents of all of which are incorporated herein by reference.

### TECHNICAL FIELD

The disclosure generally relates to the technical field of information processing, in particular to an information synchronization method, device and system.

### BACKGROUND

Along with the development of Internet times, people have more and more social demands. At present, microblog has become a necessary social tool for people in leisure time. Users can log in microblog clients through terminals such as mobile phones and TVs, join subject discussion, issue personal status, and realize social interaction with other people.

If a user wants to join a subject discussion using an existing microblog client, the user needs to manually enter the title of a subject in a fixed format, for example, a user wants to join the subject discussion of the currently hot TV series “The Journey of Flower”, the user needs to manually enter #The Journey of Flower#, and then can join the discussion group of “The Journey of Flower” to perform interaction through the microblog.

However, by using the method for joining the microblog subject discussion in the prior art, the operation is complicated because users need to manually enter the subject name.

### SUMMARY

An objective of an embodiment of the present disclosure is to provide an information synchronization method for solving the problem of complicated operation caused by the reason that users need to manually enter a subject name to join the subject discussion.

Correspondingly, an embodiment of the present disclosure also provides an information synchronization device for ensuring realization and application of the above method.

Correspondingly, an embodiment of the present disclosure also provides an information synchronization system for ensuring realization and application of the above method and device.

According to one aspect of the present disclosure, the present disclosure discloses an information synchronization method, applied to a TV, including steps of: acquiring information of a program which is being currently played; determining if a microblog account logs in on the TV; and if there is a microblog account logged in, acquiring the microblog login information; sending the program information and the microblog login information to a microblog server such that the microblog server sends the program information to a mobile terminal corresponding to the microblog login information.

According to another aspect of the present disclosure, the present disclosure discloses an information synchronization method, applied to a mobile terminal, including steps of: receiving program information sent by a TV via a microblog server; sending a request for acquiring microblog comments corresponding to the program information to the microblog server, receiving and displaying the microblog comments fed back by the microblog server according to the request for acquiring the microblog comments corresponding to the program information.

According to another aspect of the present disclosure, the present disclosure discloses a TV, which is pre-installed with a microblog client, including at least one first processor; and a first memory communicably connected with the at least one first processor for storing instructions executable by the at least one first processor, wherein execution of the instructions by the at least one first processor causes the at least one first processor to:

acquire the information of a program which is currently being played;

determine if a microblog account logs in on the TV;

acquire microblog login information if it is determined that a microblog account has logged in;

send the program information and the microblog login information to a microblog server so that the microblog server sends the program information to a mobile terminal corresponding to the microblog login information.

According to another aspect of the present disclosure, the present disclosure discloses a mobile terminal, which is pre-installed with a microblog client, including at least one second processor, and a second memory communicably connected with the at least one second processor for storing instructions executable by the at least one second processor, wherein execution of the instructions by the at least one second processor causes the at least one second processor to:

receive program information sent by a TV via a microblog server;

send a request for acquiring microblog comments corresponding to the program information received to the microblog server;

receive and display microblog comments fed back by the microblog server according to the request for acquiring microblog comments corresponding to the program information.

According to another aspect of the present disclosure, the present disclosure discloses an information synchronization system, including:

a TV, pre-installed with a microblog client, used for acquiring information of a program which is being currently played; determining if a microblog account logs in on the TV; and if so, acquiring the microblog login information; sending the program information and the microblog login information to a microblog server such that the microblog server sends the program information to a mobile terminal corresponding to the microblog login information.

The mobile terminal is pre-installed with a microblog client. The mobile terminal is in the same local area network together with the TV and is used for receiving program information sent by a microblog sever, sending a request for acquiring microblog comments corresponding to the program information to the microblog server; receiving and displaying the microblog comments fed back by the microblog server according to the request for acquiring the microblog comments corresponding to the program information.

According to another aspect of the present disclosure, embodiment of the present disclosure discloses a computer program, including computer readable codes, wherein the computer readable codes operate on an electronic device so that the electronic device executes the information synchronization method.

According to another aspect, embodiment of the present disclosure discloses a computer readable medium which stores the computer program.

The present disclosure has the following beneficial effects:

by the information synchronization method, device and system according to the embodiments of the present disclosure, the TV can send the information of a program, which is currently being played to the mobile terminal through the microblog server so that the mobile terminal can request the microblog server for the corresponding microblog comments according to the program information. Users can join in the microblog subject discussion without manually entering the subject title. The operation is simple. The present disclosure solves the problem of complicated operation caused by the reason that users need to manually enter the subject title to join the subject discussion in the prior art. Besides, according to the technical solution provided by the embodiments of the present disclosure, users can join corresponding subject discussion without knowing the title of the program, which is currently being played, bringing convenience in use and improving the user experience.

The above description is a summary of the solution of the present disclosure. In order to more clearly describe the technical means of the present disclosure, the content of the description can be executed. Moreover, in order to make the above and other objectives, characteristics and advantages of the present disclosure more understandable, embodiments of the present disclosure are described below.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart 1 of an information synchronization method according to an embodiment of the present disclosure.

FIG. 2 is a flow chart 2 of an information synchronization method according to an embodiment of the present disclosure.

FIG. 3 is a flow chart 3 of an information synchronization method according to an embodiment of the present disclosure.

FIG. 4 is a flow chart 1 of an information synchronization method according to another embodiment of the present disclosure.

FIG. 5 is a flow chart 2 of an information synchronization method according to another embodiment of the present disclosure.

FIG. 6 is a flow chart 3 of an information synchronization method according to another embodiment of the present disclosure.

FIG. 7 is a structural view 1 of a mobile terminal according to an embodiment of the present disclosure.

FIG. 8 is a structural view 2 of a mobile terminal according to an embodiment of the present disclosure.

FIG. 9 is a structural view 3 of a mobile terminal according to an embodiment of the present disclosure.

FIG. 10 is a structural view 1 of a TV according to an embodiment of the present disclosure.

FIG. 11 is a structural view 2 of a TV according to an embodiment of the present disclosure.

FIG. 12 is a structural view 3 of a TV according to an embodiment of the present disclosure.

FIG. 13 is a structural view of an information synchronization system according to an embodiment of the present disclosure.

FIG. 14 schematically illustrates a block diagram of an electronic device for executing the method according to the present disclosure.

FIG. 15 schematically illustrates a storage unit for holding or carrying program codes for realizing the method according to the present disclosure.

### DETAILED DESCRIPTION

To clarify the above objective, characteristics and advantages of the present disclosure, the present disclosure is described in further detail with reference to the attached drawings and embodiments.

In order to solve the problem of complicated operation caused by the reason that users need to manually enter a subject name to join the subject discussion, an embodiment of the present disclosure provides an information synchronization method, device and system.

As shown in FIG. 1, the information synchronization method according to an embodiment of the present disclosure, applied to a TV, includes the following steps.

Step 101: Acquire the information of a program which is currently being played.

In this embodiment, a user can watch programs in two ways: one is a signal source and the other is loop TV stations.

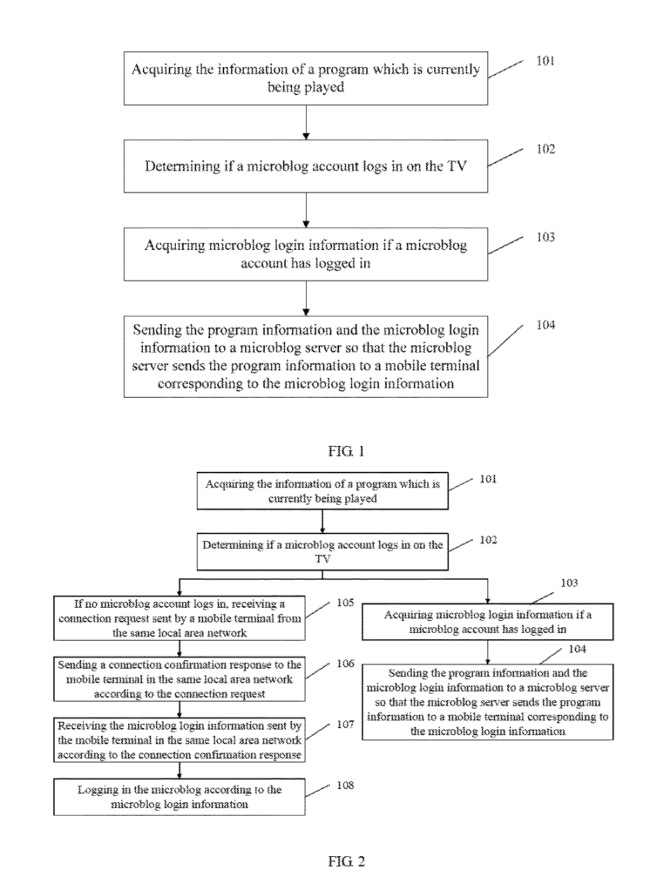

When a user uses a signal source to watch programs, as shown in FIG. 2, Step 101 is specifically to receive the name of a channel, in which a program is currently being played, sent by a TV system, sends a request, for acquiring the program information corresponding to the program which is currently being played, to a signal source server via the TV system according to the channel name, receive the program information response fed back by the signal source server, and acquire the program information corresponding to the program which is currently being played from the program information response.

When a user uses loop TV stations to watch programs, step 101 is specifically to receive program broadcast sent by loop TV stations, and acquire the program information corresponding to the program, which is currently being played from the program broadcast.

Step 102: Determine if a microblog account logs in on the TV.

Step 103: Acquire microblog login information if a microblog account has logged in.

Step 104: Send the program information and the microblog login information to a microblog server so that the microblog server sends the program information to a mobile terminal corresponding to the microblog login information.

Further, in order to solve the problem of rather complicated operation caused by manual input of a username and a password to log in microblog on a TV through using a remote controller, as shown in FIG. 2, an embodiment of the present disclosure provides an information synchronization method, also including the following steps: Step 105: If no microblog account logs in, receive a connection request sent by a mobile terminal from the same local area network.

In this embodiment, Step 105 is specifically to start a background microblog service WeiboServices, and register a mHandMessageReceiver broadcast receiver in microblog service for receiving the connection request sent by the mobile terminal via a DLNA service.

Step 106: Send a connection confirmation response to the mobile terminal in the same local area network according to the connection request.

Step 106 is specifically to, after processing the connection request, encapsulate APPKEY (application key), HASHKEY (hash signature), PACKAGEKEY (application packet name), SSIDKEY (application UID) and URL (default connection address) of the local microblog client into a JSONObject object and add a letvappinfo header identifier if finding that the message header identifier is weibofirst, namely the connection request received in Step 401, generates the connection confirmation response, and call a Util-class doPost approach to send the connection confirmation response to the mobile terminal via the DLNA service.

Step 107: Receive the microblog login information sent by the mobile terminal in the same local area network according to the connection confirmation response.

In this embodiment, after receiving the connection confirmation response, the mobile terminal encapsulates the microblog login information such as UID, ACCESSTOKEN, EXPIRESIN and REFRESHTOKEN of the user who has logged in the microblog client on the mobile terminal into a JSONObject object and adds a weibosso header identifier, calls a JniInterface-class CtrlPointSendMessageByUdn approach to send the microblog login information. Step 107 can be specifically to receive the microblog login information sent by the mobile terminal according to the connection confirmation response via the DLNA service.

Step 108: Log in the microblog according to the microblog login information.

Step 108 can be specifically to process the received microblog login information, acquires a message header weibosso, namely the microblog login information at the microblog client of the mobile terminal that a microblog account logs in, and log in the local microblog through the user data such as the UID, ACCESSTOKEN, EXPIRESIN and REFRESHTOKEN in the information.

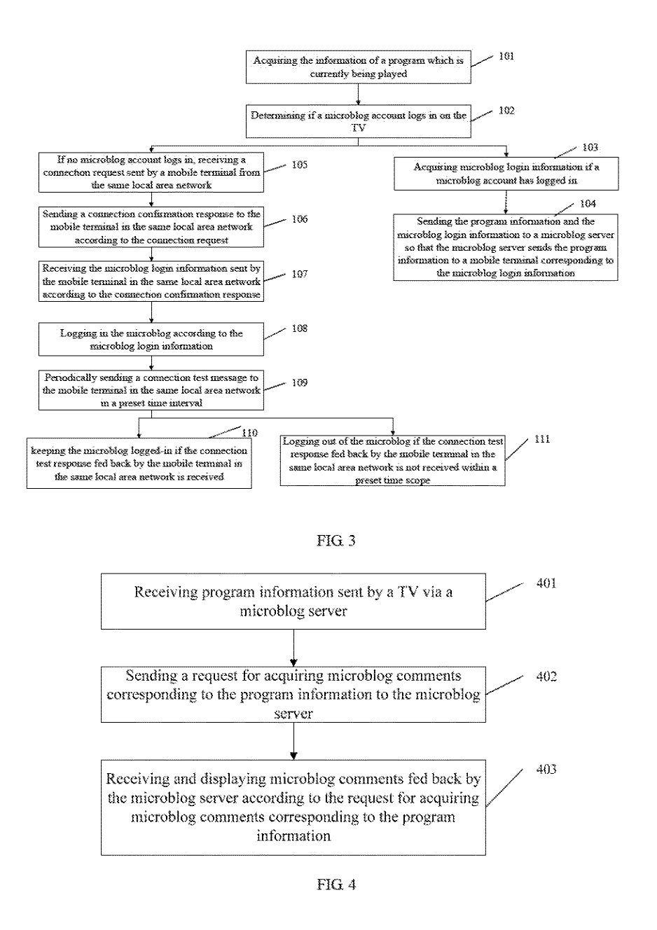

Further, as shown in FIG. 3, the information synchronization method according to the embodiment of the present disclosure also includes the following steps:

Step 109: Periodically send a connection test message to the mobile terminal in the same local area network in a preset time interval.

In this embodiment, the Step 109 is specifically to encapsulate a connection test message, which has a letvheat header identifier and includes the current time information, and call the Util-class doPost approach to send the connection test message to the mobile terminal via the DLNA service to confirm if the mobile terminal is still in the local area network.

In this embodiment, the preset time interval is 1 min. Of course, this embodiment has no specific definition on the time interval. In actual use, the time interval can be set upon needs, and therefore is not described with unnecessary details here.

Step 110: Keep the microblog logged-in if the connection test response fed back by the mobile terminal in the same local area network is received.

In this embodiment, when the mobile terminal is still in the local area network, and if the mReveivedMessage of the mobile terminal finds that the connection test message is a connection test message starting with letvheat after receiving the connection test message, the mobile terminal encapsulates a connection test response which has a weiboheat header identifier and includes the current time information, and calls a JniInterface-class CtrlPointSendMessageByUdn approach to make a feedback via the DLNA service. In Step 110, the connection test response is received via the DLNA service to determine if the mobile terminal is still in the local area network and keep the microblog logged-in.

Step 111: Log out of the microblog if the connection test response fed back by the mobile terminal in the same local area network is not received within a preset time scope.

In this embodiment, the time scope can be preset as 3 min. In Step 111, if the connection test response fed back by the mobile terminal is not received within 3 min, log out of the microblog.

It is needed to be noted that, Steps 109-111 are a method for logging out of the microblog according to an embodiment of the present disclosure. In actual use, a user can log out of the microblog in other manners, for example: setting a log-out key, or receiving a log-out command manually entered by a user to log out of the microblog. The specific log-out manners are not described in detail here.

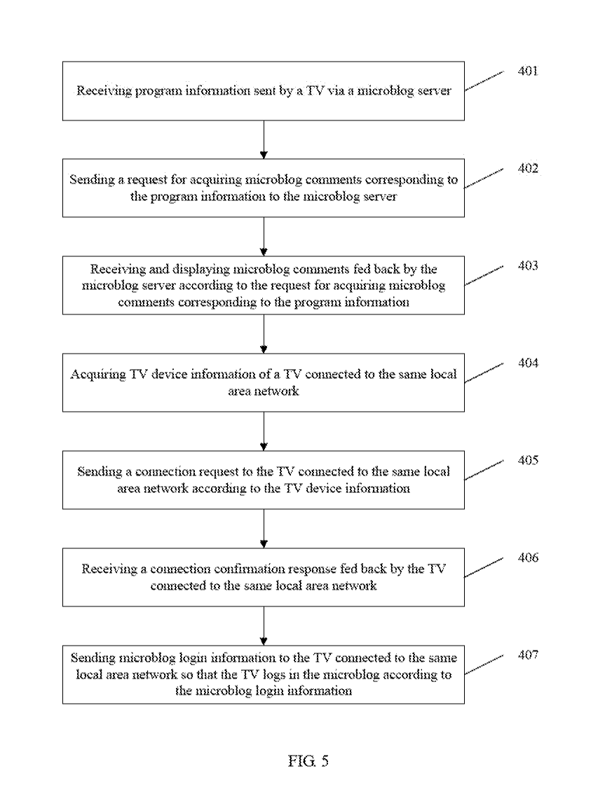

As shown in FIG. 4, another embodiment of the present disclosure also provides an information synchronization method includes the following steps.

Step 401: Receive program information sent by a TV via a microblog server.

Step 402: Send a request for acquiring microblog comments corresponding to the program information to the microblog server.

In this embodiment, when a command for opening a microblog comment or a command for viewing a microblog comment sent by a user is received, or a microblog comment command is checked, a request for acquiring microblog comments corresponding to the program information is sent to the microblog server in step 402.

Step 403: Receive and display microblog comments fed back by the microblog server according to the request for acquiring microblog comments corresponding to the program information.

Further, as shown in FIG. 5, the information synchronization method according to another embodiment of the present disclosure also includes: Step 404: Acquire TV device information of a TV connected to the same local area network.

Step 404 is specifically to: first, determine if a TV has been connected to the local area network, if so, call a JniInterface-class CtrlPointStart( ) approach to start a local digital living network alliance (DLNA) service, call a JniInterface-class CtrlPointGeDeviceList( ) approach to acquire a device list which is connected to the same local area network and starts the DLNA service after starting the DLNA service, and register an mReveivedMessage broadcast receiver to receive messages which are received via the DLNA service; and second, process the device list, filter and screen the TV device information.

Step 405: Send a connection request to the TV connected to the same local area network according to the TV device information.

Step 405 can be specifically to encapsulate a message JSONObject object with a weibofirst header identifier according to the TV device information, and call a JniInterface-class CtrlPointSendMessageByUdn approach to send the connection request to the TV via the DLNA service.

Step 406: Receive a connection confirmation response fed back by the TV connected to the same local area network.

In this embodiment, the TV is pre-installed with a microblog client. After the TV is started, the microblog client will start a background microblog service WeiboServices and registers an mHandMessageReceiver broadcast receiver in the microblog server to receive connection request sent by the TV via the DLNA service. When the mHandMessageReceiver receives and processes a connection request and finds that the message has a header identifier weibofirst, namely the connection request sent in Step 405, then APPKEY (application key), HASHKEY (hash signature), PACKAGEKEY (application packet name), SSIDKEY (application UID) and URL (default connection address) of the microblog client of the TV are encapsulated into a JSONObject object added a letvappinfo header identifier, a connection confirmation response is generated, and is sent to the mobile terminal via the DLNA service by calling a Util-class doPost approach.

Step 407: Send microblog login information to the TV connected to the same local area network so that the TV logs in the microblog according to the microblog login information.

After step 406 in which the connection confirmation response is received and processed and it is acquired that the message starts with letvappinfo, namely the connection confirmation response sent by the TV, Step 407 is specifically to encapsulate the microblog login information such as UID, ACCESSTOKEN, EXPIRESIN and REFRESHTOKEN of the user who has logged in the microblog client into a JSONObject object and add a weibosso header identifier, and call a JniInterface-class CtrlPointSendMessageByUdn approach to send the microblog login information to the TV via the DLNA service, so that the TV logs in the microblog according to the microblog login information.

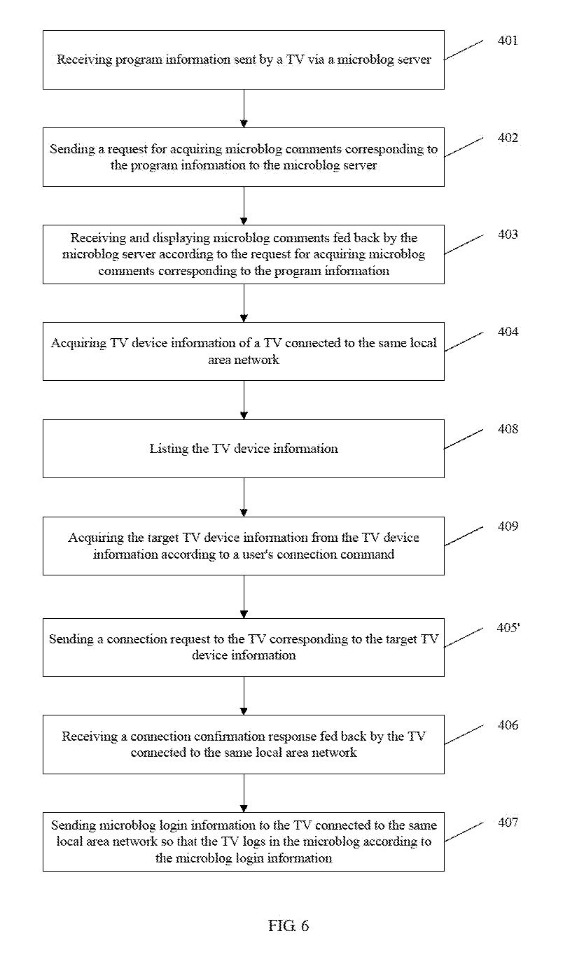

Further, when more than two pieces of TV device information are acquired in step 404, as shown in FIG. 6, the information synchronization method according to the embodiment of the present disclosure also includes the following steps:

Step 408: List the TV device information.

Step 409: Acquire the target TV device information from the TV device information according to a user's connection command.

Then, the Step 405 as shown in FIG. 5 can be directly replaced by Step 405′ to send a connection request to a TV corresponding to the target TV device information.

It needs to be noted that, for simple description, the method embodiments are described as a series of action combinations, but those skilled in this field understand that the embodiments of the present disclosure are not limited by the sequence of the described actions because according to the embodiments of the present disclosure, some steps can be implemented in other sequence or at the same time. Moreover, those skilled in this field also understand that the embodiments described in the present disclosure are all optimal embodiments, and some actions involved are not always needed by the embodiments of the present disclosure.

By the information synchronization method according to the embodiments of the present disclosure, the TV can send the information of a program that is currently being played to the mobile terminal through the microblog server so that the mobile terminal can request the microblog server for the corresponding microblog comments according to the program information. Users can join in the microblog subject discussion without manually entering the subject title. The operation is simple. The present disclosure solves the problem of complicated operation caused by the reason that users need to manually enter the subject title to join the subject discussion in the prior art. Besides, according to the technical solution provided by the embodiments of the present disclosure, users can join corresponding subject discussion without knowing the title of the program, which is currently being played, bringing convenience in use and improving the user experience.

Further, the mobile terminal can establish connection with a TV in the same local area network and send microblog login information to the TV, and the TV can automatically log in the microblog according to the microblog login information, solving the problem of complicated operation caused by manual input of a username and a password to login the microblog on the TV through the remote controller in the prior art. According to the technical solution provided by the embodiment of the present disclosure, a user can log in the microblog automatically without manually entering the microblog login information on the TV bringing convenience to operation and use.

As shown in FIG. 7, an embodiment of the present also disclosure discloses a mobile terminal, which is pre-installed with a microblog client, including:

a first receiving module 701 for receiving a program information sent by a TV via a microblog server;

a first sending module 702 for sending a request for acquiring microblog comments corresponding to the program information received by the first receiving module 701 to the microblog server;

a receiving and display module 703 for receiving and displaying microblog comments fed back by the microblog server according to the request, for acquiring microblog comments corresponding to the program information, sent by the first sending module 702.

Further, as shown in FIG. 8, the mobile terminal according to the embodiment of the present disclosure may also include:

a first acquisition module 704 for acquire TV device information of a TV connected to the same local area network;

a second sending module 705 for sending a connection request to the TV connected to the same local area network according to the TV device information acquired by the first acquisition module 704;

a second receiving module 706 for receiving a connection confirmation response fed back, according to the connection request sent by the second sending module 705, by the TV connected to the same local area network;

a third sending module 707 for sending microblog login information to the TV connected to the same local area network so that the TV logs in the microblog according to the microblog login information.

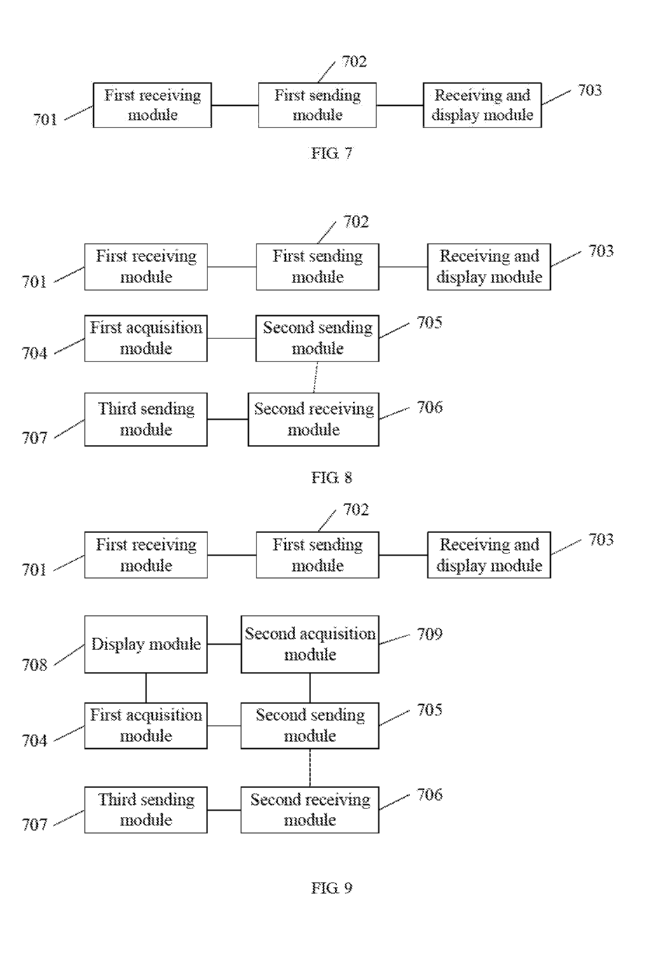

Further, as shown in FIG. 9, the mobile terminal according to the embodiment of the present disclosure may also include:

a display module 708 for displaying all TV device information in a list form if the first acquisition module 704 acquires more than two pieces of TV device information;

and a second acquisition module 709 for acquiring the target TV device information from the TV device information displayed by the display module 708 according to a user's connection command.

Then, the second sending module 705 can also be used for sending a connection request to the TV corresponding to the TV device information acquired by the second acquisition module 709.

For the specific realization method of the mobile terminal as shown in HG 7-9, refer to the information synchronization method as shown in FIG. 4-6. Unnecessary details are saved here.

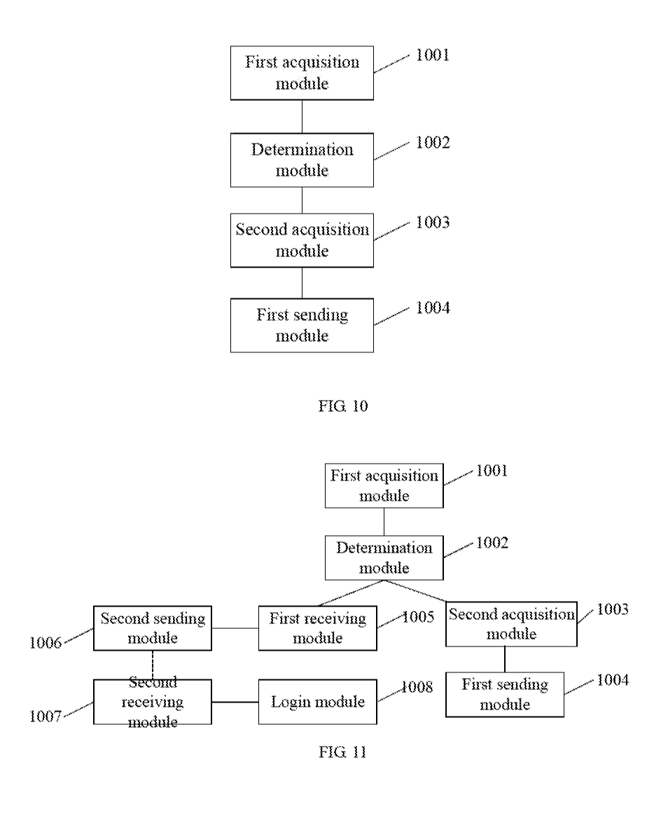

As shown in FIG. 10, an embodiment of the present also disclosure discloses a TV, which is pre-installed with a microblog client, including:

a first acquisition module 1001 for acquiring the information of a program which is currently being played;

a determination module 1002 for determining if a microblog account logs in on the TV;

a second acquisition module 1003 for acquiring microblog login information if the determination module 1002 determines that a microblog account has logged in;

a first sending module 1004 for sending the program information acquired by the first acquisition module 1001 and the microblog login information acquired by the second acquisition module 1003 to a microblog server so that the microblog server sends the program information to a mobile terminal corresponding to the microblog login information.

Further, as shown in FIG. 11, the TV according to the embodiment of the present disclosure may also include:

a first receiving module 1005 for receiving a connection request sent by a mobile terminal from the same local area network if the determination module 1002 determines that no microblog account has logged in;

a second sending module 1006 for sending a connection confirmation response to the mobile terminal in the same local area network according to the connection request received by the first receiving module 1005;

a second receiving module 1007 for receiving the microblog login information sent by the mobile terminal in the same local area network according to the connection confirmation response;

a login module 1008 for logging the microblog according to the microblog information received by the second receiving module 1007.

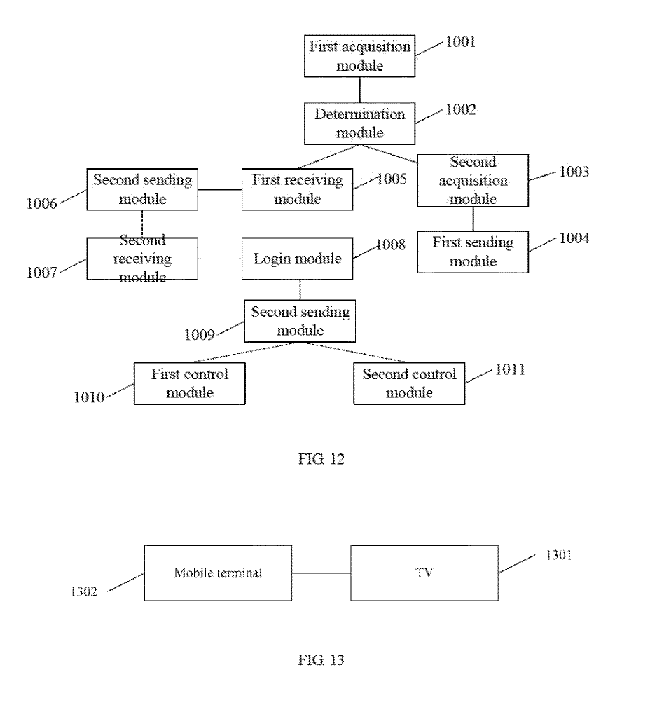

Further, as shown in FIG. 12, the TV according to the embodiment of the present disclosure may also include:

a second sending module 1009 for periodically sending a connection test message to the mobile terminal in the same local area network in a preset time interval;

a first control module 1010 for keeping the microblog logged-in if the connection test response fed back by the mobile terminal in the same local area network is received;

and a second control module 1011 for logging out of the microblog if the connection test response fed back by the mobile terminal in the same local area network is not received within a preset time scope.

For the specific realization method of the TV as shown in FIG. 10-12, refer to the information synchronization method as shown in FIG. 1-3. Unnecessary details are saved here.

By the technical solution as shown in FIG. 7-12, the TV can send the information of a program which is currently being played to the mobile terminal through the microblog server so that the mobile terminal can request the microblog server for the corresponding microblog comments according to the program information. Users can join in the microblog subject discussion without manually entering the subject title. The operation is simple. The present disclosure solves the problem of complicated operation caused by the reason that users need to manually enter the subject title to join the subject discussion in the prior art. Besides, according to the technical solution provided by the embodiments of the present disclosure, users can join corresponding subject discussion without knowing the title of the program, which is currently being played, bringing convenience in use and improving the user experience.

Further, the mobile terminal can establish connection with a TV in the same local area network and send microblog login information to the TV, and the TV can automatically log in the microblog according to the microblog login information, solving the problem of complicated operation caused by manual input of a username and a password to login the microblog on the TV through the remote controller in the prior art. According to the technical solution provided by the embodiment of the present disclosure, a user can log in the microblog automatically without manually entering the microblog login information on the TV bringing convenience to operation and use.

As shown in FIG. 13, an embodiment of the present disclosure also provides an information synchronization system, including:

a TV 1301, pre-installed with a microblog client, used for acquiring information of a program which is being currently played; determining if a microblog account logs in on the TV 1301; and if so, acquiring the microblog login information; sending the program information and the microblog login information to a microblog server such that the microblog server sends the program information to a mobile terminal 1302 corresponding to the microblog login information;

a mobile terminal 1302, which is pre-installed with a microblog client, wherein the mobile terminal 1302 is in the same local area network together with the TV 1301; and the mobile terminal 1302 is used for receiving program information sent by a microblog sever; sending a request for acquiring microblog comments corresponding to the program information to the microblog server; receiving and displaying the microblog comments fed back by the microblog server according to the request for acquiring the microblog comments corresponding to the program information.

Further, the TV 1301 is also used for, if no microblog has logged in, receiving a connection request sent by the mobile terminal 1302, sending a connection confirmation response to the mobile terminal according to the connection request, receiving the microblog login information sent by the mobile terminal 1302 according to the connection confirmation response, and logging in the microblog according to the microblog login information.

The mobile terminal 1302 is also used for acquiring the TV device information of the TV 1301, sending a connection request to the TV 1301 according to the TV device information, receiving the connection confirmation response fed back by the TV 1301 according to the connection request, and sending the microblog login information to the TV 1301.

Further, the TV 1301 is also used for periodically sending a connection test message to the mobile terminal 1302 according to a preset time interval, keeping the microblog logged-in if receiving the connection test response fed back by the mobile terminal 1302, and logging out of the microblog if not receiving the connection test response fed back by the mobile terminal 1302 within a preset time.

For specific realization method of the information synchronization system according to the embodiment of the present disclosure, refer to the information synchronization method and the information synchronization device as shown in FIG. 1-12. Unnecessary details are saved here.

By the information synchronization system according to the embodiments of the present disclosure, the TV can send the information of a program that is currently being played to the mobile terminal through the microblog server so that the mobile terminal can request the microblog server for the corresponding microblog comments according to the program information. Users can join in the microblog subject discussion without manually entering the subject title. The operation is simple. The present disclosure solves the problem of complicated operation caused by the reason that users need to manually enter the subject title to join the subject discussion in the prior art. Besides, according to the technical solution provided by the embodiments of the present disclosure, users can join corresponding subject discussion without knowing the title of the program, which is currently being played, bringing convenience in use and improving the user experience.

Further, the mobile terminal can establish connection with a TV in the same local area network and send microblog login information to the TV, and the TV can automatically log in the microblog according to the microblog login information, solving the problem of complicated operation caused by manual input of a username and a password to login the microblog on the TV through the remote controller in the prior art. According to the technical solution provided by the embodiment of the present disclosure, a user can log in the microblog automatically without manually entering the microblog login information on the TV, bringing convenience to operation and use.

All embodiments of the present disclosures are described in a progressive manner. Every embodiment focuses on different factors. Identical and similar parts of the embodiments can be reference of one another.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

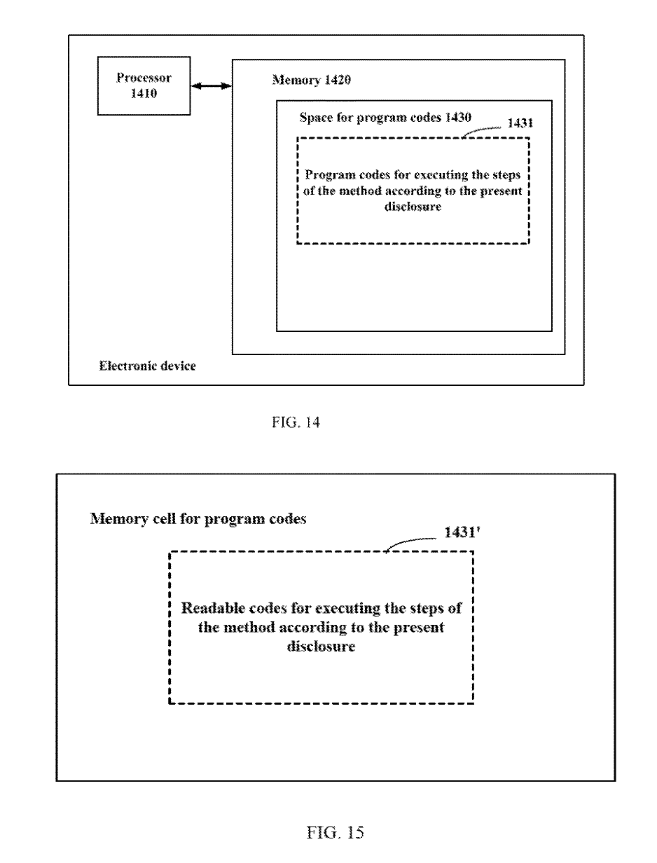

For example, FIG. 14 illustrates a block diagram of an electronic device for executing the method according the disclosure. Traditionally, the electronic device includes a processor 1410 and a computer program product or a computer readable medium in form of a memory 1420. The memory 1420 could be electronic memories such as flash memory, EEPROM (Electrically Erasable Programmable Read-Only Memory), EPROM, hard disk or ROM. The memory 1420 has a memory space 1430 for executing program codes 1431 of any steps in the above methods. For example, the memory space 1430 for program codes may include respective program codes 1431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 15. The memory cells may be provided with memory sections, memory spaces, etc., similar to the memory 1420 of the server as shown in FIG. 14. The program codes may be compressed for example in an appropriate form. Usually, the memory cell includes computer readable codes 1431′ which can be read for example by processors 1410. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”. “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The embodiments of the present disclosure are described with reference to the flow charts and/or block diagrams of the methods and terminal devices (system) and computer program products of the embodiments of the present disclosure. It should be understood that the computer program commands realize every process and/or block in the flow charts and/or block diagrams and the combination of processes and/or blocks in the flow charts and/or block diagrams. The computer program command can be supplied to the processor of a universal computer, a special computer, an embedded processing machine or other programmable data processing terminals to generate a machine, so the commands executed by the processor of the computer or other programmable data processing terminal device generate a device for realizing specific functions in one or more processes in the flow charts and/or one or more blocks in the block diagrams.

The computer program commands can also be stored in computer readable memories which guide the computer or other data processing terminal devices to work in a specific mode, so the commands stored in the computer readable memories generate products including command devices, and the command devices conduct specific functions in one or more processes in the flow charts and/or one or more blocks in the block diagrams.

The computer program commands can also be loaded in the computer or other programmable data processing terminal devices such that computer or other programmable data processing terminal devices execute a series of operations to generate processing executed by the computer. Thus, the commands executed in the computer or other programmable data processing terminal devices supply steps of conducting specific functions in one or more processes in the flowcharts and/or one or more blocks in the block diagrams.

The above are detailed description of the information synchronization method, device and system of the present disclosure. Specific examples are used in the text to describe the principle and implementation mode of the present disclosure. The description of the above embodiments is only used for the purpose of clarifying the method and essential concepts of the present disclosure. Meanwhile, for those ordinarily skilled in this field, changes may be made to the specific implementation modes and application scope according to the concept of the present disclosure. In conclusion, the contents of the Description cannot be regarded as limit in the present disclosure.

What is claimed is:

1. A method for information synchronizating, applied to a TV, comprising:
acquiring the information of a program which is currently being played;
determining if a microblog account logs in on the TV;
acquiring microblog login information if a microblog account has logged in;
sending the program information and the microblog login information to a microblog server so that the microblog server sends the program information to a mobile terminal corresponding to the microblog login information.

2. The method according to claim 1, further comprising:
if no microblog account logs in, receiving a connection request sent by a mobile terminal from the same local area network;
sending a connection confirmation response to the mobile terminal in the same local area network according to the connection request;
receiving the microblog login information sent by the mobile terminal in the same local area network according to the connection confirmation response;
and logging in the microblog according to the microblog login information.

3. The method according to claim 2, further comprising:
periodically sending a connection test message to the mobile terminal in the same local area network in a preset time interval;
keeping the microblog logged-in if the connection test response fed back by the mobile terminal in the same local area network is received;
logging out of the microblog if the connection test response fed back by the mobile terminal in the same local area network is not received within a preset time scope.

4. A method for information synchronizating, applied to a mobile terminal, comprising:
receiving program information sent by a TV via a microblog server;
sending a request for acquiring microblog comments corresponding to the program information to the microblog server;
receiving and displaying microblog comments fed back by the microblog server according to the request for acquiring microblog comments corresponding to the program information.

5. The method according to claim 4, further comprising:
acquiring TV device information of a TV connected to the same local area network;
sending a connection request to the TV connected to the same local area network according to the TV device information;
receiving a connection confirmation response fed back by the TV connected to the same local area network;
and sending microblog login information to the TV connected to the same local area network so that the TV logs in the microblog according to the microblog login information.

6. The method according to claim 5, further comprising:
displaying all TV device information in a list form in the case of more than two pieces of TV device information;
acquiring the target TV device information from the TV device information according to a user's connection command;
wherein the step of sending a connection request to the TV connected to the same local area network according to the TV device information is replaced by the step of:
sending a connection request to the TV corresponding to the target TV device information.

7. An electronic device, pre-installed with a microblog client, comprising:
at least one first processor; and
a first memory communicably connected with the at least one first processor for storing instructions executable by the at least one first processor, wherein execution of the instructions by the at least one first processor causes the at least one first processor to:
acquire the information of a program which is currently being played;
determine if a microblog account logs in on a TV;
acquire microblog login information if it is determined that a microblog account has logged in;
send the program information and the microblog login information to a microblog server so that the microblog server sends the program information to a mobile terminal corresponding to the microblog login information.

8. The electronic device according to claim 7, wherein execution of the instructions by the at least one processor causes the at least one processor to further:
receive a connection request sent by a mobile terminal from the same local area network if it is determined that no microblog account has logged in;
send a connection confirmation response to the mobile terminal in the same local area network according to the connection request received by the first receiving module;
receive the microblog login information sent by the mobile terminal in the same local area network according to the connection confirmation response;
log the microblog according to the microblog login information.

9. The electronic device according to claim 8, wherein execution of the instructions by the at least one processor further causes the at least one processor to:
periodically send a connection test message to the mobile terminal in the same local area network within a preset time interval;
keep the microblog logged-in if the connection test response fed back by the mobile terminal in the same local area network is received;
a log out of the microblog if the connection test response fed back by the mobile terminal in the same local area network is not received within a preset time scope.
